(19) United States
(12) Patent Application Publication
(10) Pub. No.: US 2011/0043694 A1
(43) Pub. Date: Feb. 24, 2011

(54) TRANSMITTING APPARATUS, RECEIVING APPARATUS AND CONTENTS REPRODUCING SYSTEM

(76) Inventors: Takashi Izuno, Tokyo (JP); Shinya Sasatani, Kanagawa (JP); Toshitaka Asai, Saitama (JP)

Correspondence Address: NIXON & VANDERHYE, PC, 901 NORTH GLEBE ROAD, 11TH FLOOR, ARLINGTON, VA, 22203, US

(21) Appl. No.: 12/934,166

(22) PCT Filed: Mar. 28, 2008
(86) PCT No.: PCT/JP2008/056052

§ 371 Date: Nov. 1, 2010

(51) Int. Cl. H04N 9/475

(52) U.S. Cl. 348/515; 348/E09.034

(57) ABSTRACT

A transmitting apparatus connects to a receiving apparatus via a transmission medium, and transmits contents based on an audio transmitting clock. The transmitting apparatus includes a frequency deviation receiving unit and a clock varying unit. The frequency deviation receiving unit receives, from the receiving apparatus, information indicating a frequency deviation between the audio transmitting clock and an audio reproducing clock. The clock varying unit varies a transmitting-side system clock based on the information of the frequency deviation obtained from the receiving apparatus. The receiving apparatus includes an audio reproducing clock generating unit. The receiving apparatus buffers the audio data by the audio transmitting clock, and transfers the audio data from the buffer to a DAC in accordance with the audio reproducing clock, so as to eliminate the audio quality deteriorating factor caused by a receiving circuit of the transmitting apparatus and the receiving apparatus. Further, the receiving apparatus detects the frequency deviation between the audio transmitting clock and the audio reproducing clock and transmits its information to the transmitting apparatus so that the buffer does not cause an overflow and an underflow.

### TECHNICAL FIELD

The present invention relates to a system which transmits contents between two equipments via a transmission medium and reproduces the contents.

### BACKGROUND TECHNIQUE

There is known a contents reproducing system including a transmitting apparatus (player) which provides contents via a digital interface such as HDMI (High Definition Multimedia Interface), and a receiving apparatus (receiver) which receives the contents and outputs it.

In such a contents reproducing system, there is proposed a method of varying an audio data transmission rate in order to prevent an overflow and an underflow of a receiving buffer (For example, see. Patent Document-1).

Patent Document-1:

Japanese Patent Application Laid-open under No. 2007-194845

### DISCLOSURE OF INVENTION

### Problem to be Solved by the Invention

However, the method disclosed in the Patent Document-1 does not consider the synchronization of audio and video. In the Patent Document-1, since the transmitting apparatus performs the control of varying only the audio data transmission rate by a predetermined amount (For example, ±1% or ±0.1%), there is such a problem that the audio output and the video output in the transmitting apparatus gradually become deviated from each other. When the above-mentioned deviation is accumulated, the transmitting apparatus generally performs skip process or repeat process of video in order to prevent the overflow and the underflow of the output buffer. By this, there is a possibility that visual problem occurs.

A problem to be solved by the present invention includes the above-mentioned one as an example. It is an object of the present invention to prevent the overflow and the underflow of the buffer on the receiver side by appropriately adjusting the system clock frequency of the transmitting apparatus.

### Means for Solving the Problem

According to an invention of claim 1, a transmitting apparatus which transmits audio data of contents, to a receiving apparatus electro-magnetically connected via a transmission medium, in accordance with an audio transmitting clock generated based on a transmitting-side system clock, comprises: a frequency deviation receiving unit which receives information indicating a frequency deviation between the audio transmitting clock and an audio reproducing clock of the receiving apparatus; and a clock varying unit which varies the transmitting-side system clock based on the information.

According to an invention of claim 5, a receiving apparatus which receives audio data, via a transmission medium, transmitted in accordance with an audio transmitting clock generated based on a transmitting-side system clock and transmitted from a transmitting apparatus, comprises: a buffer; a clock generating unit which generates an audio reproducing clock; and a frequency deviation calculating unit which calculates a frequency deviation between the audio transmitting clock and the audio reproducing clock, wherein the frequency deviation calculating unit calculates the frequency deviation based on a variation amount, per unit time, of the audio data accumulated in the buffer.

According to an invention of claim 8, a contents reproducing system comprises: a transmission medium; a transmitting apparatus which transmits audio data of contents via the transmission medium in accordance with an audio transmitting clock generated based on a transmitting-side system clock; and a receiving apparatus which receives the contents via the transmission medium and reproduces the contents in accordance with an audio reproducing clock generated by a clock generating unit, wherein the receiving apparatus comprises: a frequency deviation calculating unit which calculates a frequency deviation between the audio transmitting clock and the audio reproducing clock; and a frequency deviation transmitting unit which transmits information indicating the frequency deviation to the transmitting apparatus, and wherein the transmitting apparatus comprises: a frequency deviation receiving unit which receives the information from the receiving apparatus; and a clock varying unit which varies the transmitting-side system clock based on the information.

### BRIEF DESCRIPTION OF THE DRAWINGS

FIG. 1 is a diagram showing a configuration of a contents reproducing apparatus.

FIG. 2 is a block diagram of a clock synchronizing process according to an embodiment.

FIG. 3A is a diagram showing an example of a graph of a buffer amount variation according to the passage of time.

FIG. 3B is a diagram showing an example of a graph of a relation between a buffer variation amount and a frequency deviation.

FIG. 4 is a diagram showing an example of a database according to the embodiment.

FIG. 5 is a flowchart showing a process in the embodiment.

FIG. 6 is a diagram showing a configuration of a transmitting apparatus according to a modified example.

### BRIEF DESCRIPTION OF REFERENCE NUMBERS

100 Transmitting apparatus
200 Receiving apparatus
201 Clock generating unit
103, 203 Control unit
104 Auxiliary storage unit
105 Transmitting unit
205 Receiving unit
209 Communication control unit
300 Transmission medium

### DETAILED DESCRIPTION OF THE PREFERRED EMBODIMENTS

According to one aspect of the present invention, there is provided a transmitting apparatus which transmits audio data of contents, to a receiving apparatus electro-magnetically connected via a transmission medium, in accordance with an audio transmitting clock generated based on a transmitting-side system clock, comprising: a frequency deviation receiving unit which receives information indicating a frequency deviation between the audio transmitting clock and an audio reproducing clock of the receiving apparatus; and a clock varying unit which varies the transmitting-side system clock based on the information.

The above transmitting apparatus connects to the receiving apparatus via an AV (Audio Visual) cable in conformity with HDMI, etc., and transmits the audio data based on the audio transmitting clock. The transmitting apparatus includes the frequency deviation receiving unit and the clock varying unit. The frequency deviation receiving unit receives, from the receiving apparatus, information indicating the frequency deviation, between the audio transmitting clock and the audio reproducing clock by which the receiving apparatus reproduces the audio data. The clock varying unit varies the transmitting-side system clock based on the information of the frequency deviation obtained from the receiving apparatus. Since the audio transmitting clock follows the transmitting-side system clock, the transmitting apparatus can control the accumulated amount of the buffer on the receiving-side consequently, and the overflow and the underflow of the buffer on the receiving-side can be prevented. In addition, since the clock used to transmit the video also follows the transmitting-side system clock, the transmitting apparatus can prevent the occurrence of deviation of the video and the audio to be outputted.

One mode of the above transmitting apparatus further comprises a storing unit which stores the frequency deviation in association with equipment identification information of the receiving apparatus. In this mode, the identification information of the receiving apparatus and the frequency deviation of the receiving apparatus are stored in association with each other. By this, when the transmitting apparatus connects to the receiving apparatus again to reproduce the contents, the transmitting apparatus can use the frequency of the audio transmitting clock close to the frequency of the audio reproducing clock in advance, and can correct the transmitting-side system clock early.

Another mode of the above transmitting apparatus further comprises: a voltage-controlled oscillator which controls an oscillating frequency by a voltage; and a voltage generator which generates the voltage applied to the voltage controlled oscillator, wherein the clock varying unit controls the voltage generated by the voltage generator based on the frequency deviation. In this mode, the transmitting apparatus includes the voltage-controlled oscillator and the voltage generator. Thus, the transmitting apparatus can easily vary the oscillating clock by controlling the voltage of the voltage generator.

In another mode of the transmitting apparatus, the voltage generator has a function to control a transition from a standby condition to a normal operating condition. In this mode, the clock varying unit controls the transmitting-side system clock based on the voltage generated by the voltage generator. Thereby, the power of the transmitting apparatus can be controlled without adding a device such as a stand-by microcomputer, and the control of the voltage generator can be simplified.

According to another aspect of the present invention, there is provided a receiving apparatus which receives audio data, via a transmission medium, transmitted in accordance with an audio transmitting clock generated based on a transmitting-side system clock and transmitted from a transmitting apparatus, comprising: a buffer; a clock generating unit which generates an audio reproducing clock; and a frequency deviation calculating unit which calculates a frequency deviation between the audio transmitting clock and the audio reproducing clock, wherein the frequency deviation calculating unit calculates the frequency deviation based on a variation amount, per unit time, of the audio data accumulated in the buffer. The buffer temporarily accumulates the audio data of the contents. The frequency deviation calculating unit calculates the frequency deviation based on the variation amount, per unit time, of the buffer during the reproduction of the audio data. By this, the frequency deviation between the audio transmitting clock and the audio reproducing clock can be accurately calculated.

In one mode of the above receiving apparatus, the frequency deviation calculating unit calculates the frequency deviation by measuring a frequency of the audio reproducing clock and a frequency of the audio transmitting clock. The frequency deviation can also be accurately calculated by the receiving apparatus which measures the audio transmitting clock of the transmitting apparatus and the audio reproducing clock of the receiving apparatus by using a DSP (Digital Signal Processor) and the like.

Another mode of the above receiving apparatus further comprises a frequency deviation transmitting unit which transmits information indicating the frequency deviation obtained by the frequency deviation calculating unit to the transmitting apparatus. By this, the calculated frequency deviation can be transmitted to the transmitting apparatus.

According to still another aspect of the present invention, there is provided a contents reproducing system comprising: a transmission medium; a transmitting apparatus which transmits audio data of contents via the transmission medium in accordance with an audio transmitting clock generated based on a transmitting-side system clock; and a receiving apparatus which receives the contents via the transmission medium and reproduces the contents in accordance with an audio reproducing clock generated by a clock generating unit, wherein the receiving apparatus comprises: a frequency deviation calculating unit which calculates a frequency deviation between the audio transmitting clock and the audio reproducing clock; and a frequency deviation transmitting unit which transmits information indicating the frequency deviation to the transmitting apparatus, and wherein the transmitting apparatus comprises: a frequency deviation receiving unit which receives the information from the receiving apparatus; and a clock varying unit which varies the transmitting-side system clock based on the information.

The above contents reproducing system includes a transmission medium, a transmitting apparatus and a receiving apparatus. The transmission medium may be an AV cable in conformity with HDIM, for example. The transmitting apparatus transmits the audio data of the contents to the receiving apparatus via the transmission medium in accordance with the audio transmitting clock. The receiving apparatus is an apparatus which reproduces the contents in accordance with the audio reproducing clock generated by the clock generating unit, and includes the frequency deviation calculating unit and the frequency deviation transmitting unit. The frequency deviation calculating unit calculates the frequency deviation between the audio transmitting clock and the audio reproducing clock. The frequency deviation transmitting unit transmits the information indicating the frequency deviation obtained by the frequency deviation calculating unit to the transmitting apparatus. The transmitting apparatus includes the frequency deviation receiving unit and the clock varying unit. The frequency deviation receiving unit receives the information indicating the frequency deviation that the receiving apparatus calculated. The clock varying unit adjusts the transmitting-side system clock based on the obtained frequency deviation. In this way, in a case that the contents include the video data and the audio data, the contents can be appropriately reproduced in such a manner that the video and the audio are synchronized.

In one mode of the above contents reproducing system, the receiving apparatus further comprises a buffer which temporarily accumulates the audio data, and the frequency deviation calculating unit calculates the frequency deviation based on a variation amount, per unit time, of the audio data accumulated in the buffer. By this, the frequency deviation can be accurately calculated.

In another mode of the above contents reproducing system, the frequency deviation calculating unit calculates the frequency deviation by measuring a frequency of the audio reproducing clock and a frequency of the audio transmitting clock. Also by this mode, the frequency deviation can be accurately calculated.

### EMBODIMENT

A preferred embodiment of the present invention will be described below with reference to the attached drawings.

[Schematic Configuration of Reproducing System]

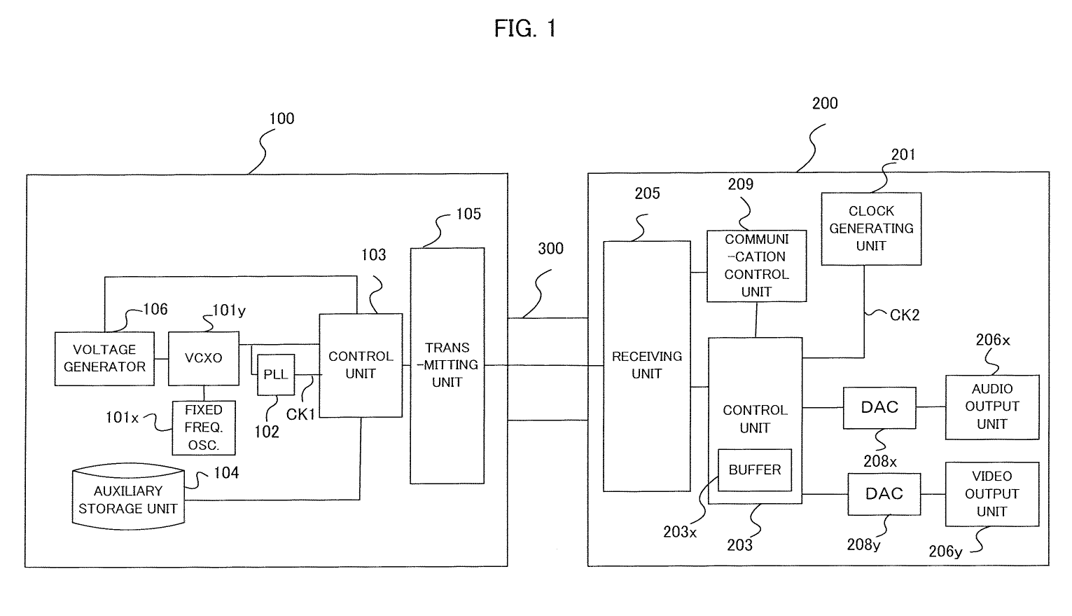

FIG. 1 shows a schematic diagram of a reproducing system (hereinafter referred to as “contents reproducing system”) of reproducing data (hereinafter referred to as “contents”), which includes video data, audio data or both of the video data and the audio data, according to a present embodiment. The contents reproducing system includes a transmitting apparatus 100, a receiving apparatus 200 and a transmission medium 300. The functions and the configurations of them will be described below.

The transmitting apparatus 100 is an apparatus which decodes the contents, and transmits the contents to the receiving apparatus 200 via the transmission medium 300. The transmitting apparatus 100 includes a fixed frequency oscillator 101x, a VCXO (Voltage Controlled Crystal Oscillator) 101y, a PLL (Phase Locked Loop) 102, a control unit 103, an auxiliary storage unit 104, a transmitting unit 105 and a voltage generator 106.

The fixed frequency oscillator 101x generates a periodic clock signal (hereinafter referred to as “a transmitting-side system clock”) for taking a timing (i.e., establishing synchronization) at the time when the transmitting apparatus 100 operates. The VCXO 101y is a crystal oscillator capable of varying the frequency depending upon the voltage. In this embodiment, the VCXO 101y generates a clock (hereinafter referred to as “a video transmitting clock”) used as a basis for transmitting the video data to the receiving apparatus 200, based on the transmitting-side system clock. The VCXO 101y corresponds to the clock generating unit of the present invention. The PLL 102 is a PLL circuit which generates a clock CK1 (hereinafter referred to as “audio transmitting clock CK1”) used as a basis for transmitting the audio data to the receiving apparatus 200, based on the video transmitting clock outputted by the VCXO 101y.

The auxiliary storage unit 104 is used to store program to control the operation of the transmitting apparatus 100 and to store information necessary for the operation of the transmitting apparatus 100. The auxiliary storage unit 104 may be realized by a hard disk (HDD: Hard Disk Drive), a semiconductor disc, an optical disc and the like. In this embodiment, the auxiliary storage unit 104 stores the contents which the receiving apparatus 200 reproduces. Further, the auxiliary storage unit 104 has a database including, as items, the audio transmitting clock CK1 of the transmitting apparatus 100 and the identification information of the transmitting apparatus 100. These will be described later in more detail.

The control unit 103 includes a CPU (Central processing Unit), a RAM (Random Access Memory) and a ROM (Read Only Memory), which are not shown, and performs the general control of the transmitting apparatus 100. In this embodiment, the control unit 103 reads out the contents stored in the auxiliary storage unit 104 and performs the decode processing. Also, the control unit 103 transmits, to the voltage generator 106, the signal to control the voltage generated by the voltage generator 106. Also, the control unit 103 transmits the video data and the audio data of the contents to the transmitting unit 105 based on the video transmitting clock generated by the VCXO 101y and the audio transmitting clock CK1 generated by the PLL 102. The control unit 103 may be configured by SOC (System On a Chip), for example.

The voltage generator 106 is a circuit which generates the voltage to be supplied to the VCXO 101y. The voltage generator 106 generates the voltage based on the control signal from the control unit 103.

In addition to the above-mentioned voltage generating function, the voltage generator 106 is a circuit including a so-called power-on-reset function, i.e., a function to store the condition immediately before the power of the transmitting apparatus 100 is cut and to control the transition from a condition, in which the operation can be restarted from the condition immediately before the power-off (hereinafter referred to as “standby condition”), to a condition in which the transmitting apparatus 100 can perform its function (hereinafter referred to as “normal operating condition”), when the transmitting apparatus 100 is powered ON at the next time. Thereby, the transmitting apparatus 100 can start the control unit 103, without adding a device such as a stand-by microcomputer to start the transmitting-side system clock used to start the control unit 103, and the control unit 103 can directly control the voltage generator 106 after its start.

The transmitting unit 105 transmits the contents decoded by the control unit 103 to the receiving apparatus 200 according to a predetermined protocol, and transmits and receives the control signal as needed. Also, the transmitting unit 105 replaces the audio transmitting clock CK1 with algebra based on the video transmitting clock. Namely, the transmitting unit 105 changes the audio transmitting clock CK1 to the data associated with the video transmitting clock, and transmits it to the receiving apparatus 200. The transmitting unit 105 may be configured by a digital interface such as HDMI and IEEE (Institute of Electrical and Electronic Engineers) 1394 interface. The transmitting unit 105 may perform wireless communication, instead of wired communication. In this case, the transmitting unit 105 is configured by a network adapter for wireless communication and the like. In the following description, it is assumed that the transmitting unit 105 is configured by an interface in conformity with HDMI, as a representative example.

The transmission medium 300 is a medium for electro-magnetically transmitting the contents and the control signal between the transmitting apparatus 100 and the receiving apparatus 200. For example, the transmission medium 300 may be realized by an AV cable or a coaxial cable of various kind, or a wireless LAN router and wireless LAN access points in case of the wireless communication. In this embodiment, it is assumed that the transmission medium 300 is realized by an AV cable in conformity with HDMI.

The receiving apparatus 200 is an apparatus to receive the contents from the transmitting apparatus 100 and output the contents. The receiving apparatus 200 includes a clock generating unit 201, a control unit 203, a receiving unit 205, an audio output unit 206x, a video output unit 206y, DACs (Digital to Analog Converters) 208x and 208y, and a communication control unit 209.

The clock generating unit 201 generates a periodic clock signal CK2 (hereinafter referred to as “an audio reproducing clock CK2”) for taking timing (i.e., establishing synchronization) when the receiving apparatus 200 performs audio reproduction. For example, a control signal included in the audio signal may be used as information to generate the audio reproducing clock CK2.

The receiving unit 205 receives the contents decoded by the transmitting unit 100 via the transmission medium 300. Also, the receiving unit 205 regenerates, by a PLL not shown, the audio transmitting clock CK1 algebraized by the transmitting unit 105. The audio transmitting clock CK1, which is regenerated by the receiving unit 205, will be hereinafter simply referred to as “a regenerated audio clock”. The receiving unit 205 may be realized by a digital interface in conformity with HDMI or a wireless network adapter, like the transmitting unit 105. In the following description, it is assumed that the receiving unit 205 is realized by an interface in conformity with HDMI.

The control unit 203 is a circuit to perform signal processing necessary to reproduce the contents. Also, the control unit 203 includes a CPU, a RAM and a ROM, which are not shown, and performs the general control of the receiving apparatus 200. The control unit 203 includes a buffer 203x to temporarily accumulate the audio data received from the transmitting apparatus 100. The control unit 203 takes out the audio data from the internal buffer 203x based on the audio reproducing clock CK2 generated by the clock generating unit 201, and supplies the audio data to the DAC 208x. Also, the control unit 203 supplies the video data, which the receiving unit 205 receives, to the DAC 208y without accumulating it. The control unit 203 may be realized by a DSP (Digital Signal Processor), for example.

The communication control unit 209 is a circuit to control the communication of the control signal. The communication control unit 209 generates and decodes the control commands communicated via a CEC (Consumer Electronics Control) line, which is a control communication channel (a signal line for control) in HDMI.

The DAC 208x receives the supply of the audio data, which is a digital signal, from the control unit 203, and performs the DA conversion of the audio data. Then, the DAC 208x supplies the generated audio analog signal to the audio output unit 206x.

The audio output unit 206x has an amplifying function to amplify the audio analog signal, and an audio outputting function to convert the amplified audio analog signal to an audio and outputs it. For example, the amplifying function may be realized by an amplifier, and the audio outputting function may be realized by speakers.

The DAC 208y receives the supply of the video data, which is a digital signal, from the receiving unit 205 via the control unit 203, and performs the DA conversion of the video data. Then, the DAC 208y supplies the generated video analog signal to the video output unit 206y. The DAC 208y may be configured to receive the video data supplied from the receiving unit 205, without passing through the control unit 203.

The video output unit 206y displays the video analog signal supplied from the DAC 208y on a display device such as a display. The display device may be realized by a CRT (Cathode Ray Tube), a liquid crystal display, a PDP, an organic EL and a projector.

[Reproducing Method]

Next, the reproducing method of the contents by the receiving apparatus 200 will be specifically described. In reproducing the audio data, it is conceivable to use the regenerated audio clock (hereinafter referred to as “Comparative Example-1”) In the Comparative Example-1, the audio data is not stored in the buffer 203x, and the received audio data is outputted one after another. However, the regenerated audio clock is affected by the jitter of the video transmitting clock and the performance of the PLL which generates the regenerated audio clock. Therefore, the influence by the jitter and the like, mentioned above, may be a cause of the sound quality deterioration.

On the other hand, it is conceivable to generate the audio reproducing clock CK2 by the clock generating unit 201 to reproduce the audio data (hereinafter referred to as “Comparative Example-2”), instead of using the regenerated audio clock like the Comparative Example-1. This method corresponds to a technique generally called as “Command based audio rate control (hereinafter referred to as “ARC”). In this case, the receiving apparatus 200 temporarily accumulates the audio data in the buffer 203x of the control unit 203, and outputs the audio data in accordance with the audio reproducing clock CK2. In the Comparative Example-2, when the audio transmitting clock CK1 generated by the transmitting apparatus 100 is different from the audio reproducing clock CK2 oscillated by the receiving apparatus 200, the data amount accumulated in the buffer 203x (hereinafter referred to as “buffer amount”) varies, and an underflow and/or an overflow may occur. In order to overcome this problem, in the Comparative Example-2, the thresholds corresponding to the upper limit and the lower limit are introduced to the buffer amount, respectively. If the buffer amount becomes larger than the threshold of the upper limit, the control signal is transmitted to the transmitting apparatus 100 to lower the frequency of the audio transmitting clock CK1 of the transmitting apparatus 100. Thus, the rate of the audio data transmitted from the transmitting apparatus 100 decreases, and the overflow of the buffer 203x can be prevented. Similarly, if the buffer amount becomes smaller than the threshold of the lower limit, the receiving apparatus 200 transmits the control signal to raise the frequency of the audio transmitting clock CK1. By this, the rate of the audio data transmitted from the transmitting apparatus 100 increases, and the underflow of the buffer 203x can be prevented. The above-mentioned transmission of the control signal is realized by the CEC line. By operating as described above, the audio data can be outputted with high quality in the Comparative Example-2.

However, the Comparative Example-2 does not consider the synchronization of the video data and the audio data. Therefore, there may occur a so-called “lip-sync” in which the output of the video data does not synchronize with the output of the audio data, and the lip movement in the reproduced picture does not coincide with the corresponding audio output. Particularly, when the control signal is transmitted to vary the audio transmitting clock CK1 of the transmitting apparatus 100, the variation of the clock is not applied to the video transmitting clock but is applied only to the audio data, and hence the lip-sync becomes remarkable. Then, in order to overcome the deviation between the video data and the audio data, the decoder of the control unit 103 in the transmitting apparatus 100 performs the skip or repeat processing of the video.

Therefore, in this embodiment, the occurrence of the jitter in the Comparative Example-1 and the lip-sync occurring in the Comparative Example-2 are prevented by performing a processing (hereinafter referred to as “clock synchronizing processing”) which adjusts the audio transmitting clock CK1 generated by the transmitting apparatus 100 to coincide with the audio reproducing clock CK2 generated by the receiving apparatus 200.

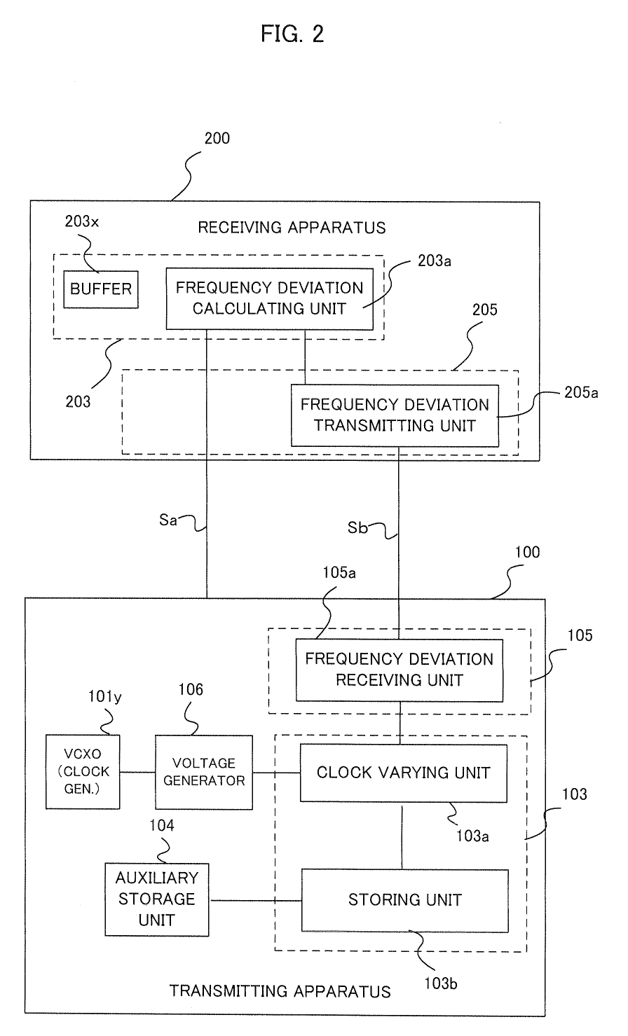

This will be described with reference to FIG. 2. FIG. 2 shows a block diagram of the clock synchronizing processing according to this embodiment. In the receiving apparatus 200, the control unit 203 includes a frequency deviation calculating unit 203a, and the receiving unit 205 includes a frequency deviation transmitting unit 205a. In the transmitting apparatus 100, the transmitting unit 105 includes a frequency deviation receiving unit 105a, and the control unit 103 includes a clock varying unit 103a and a storing unit 103b.

First, at the time of reproducing the contents, the transmitting apparatus 100 transmits the decoded contents to the receiving apparatus 200 via the transmission medium 300. The receiving apparatus 200 stores the audio data Sa of the received contents in the buffer 203x in the control unit 203. The audio data Sa may be the audio data used in the reproduction, or may be dummy data for the clock synchronizing processing. Then, the control unit 203 calculates the frequency deviation between the frequency of the audio transmitting clock CK1 and the audio reproducing clock CK2 (hereinafter simply referred to as “frequency deviation”), by the frequency deviation calculating unit 203a.

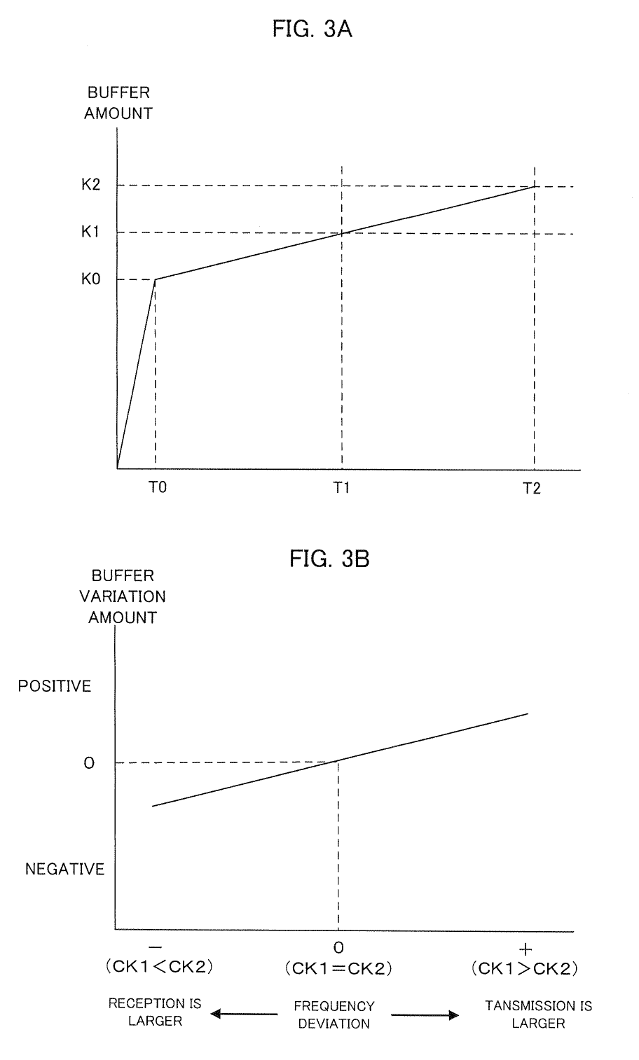

Here, the calculating method of the frequency deviation will be described. FIG. 3A is a diagram showing an example of a graph of the buffer amount variation of the buffer 203x in the control unit 203 according to the passage of time. As shown in FIG. 3A, the control unit 203 does not take out the audio data from the buffer 203x until the predetermined time T0 so as to make the buffer amount to be equal to the predetermined amount K0. Then, when the buffer amount becomes equal to the predetermined amount K0 at the time T0, the control unit 203 takes out the audio data accumulated in the buffer 203x based on the audio reproducing clock CK2 generated by the clock generating unit 201. Then, the control unit 203 performs the processing of taking out the audio data based on the audio reproducing clock CK2 after the time T0, and monitors the buffer amount. In FIG. 3A, from the time T1 to the time T2, the buffer amount changes from K1 to K2. Therefore, the control unit 203 can measure the variation amount of the buffer amount per unit time (hereinafter simply referred to as “buffer variation amount”).

Next, the control unit 203 calculates the frequency deviation between the audio transmitting clock CK1 and the audio reproducing clock CK2 from the buffer variation amount. This method will be described in detail. The audio data amount accumulated in the buffer 203x per unit time is determined by the frequency of the audio transmitting clock CK1 that the transmitting apparatus 100 generates by the PLL 102. Also, the audio data amount read out from the buffer 203x per unit time is determined by the frequency of the audio reproducing clock CK2. Namely, since the frequency deviation and the buffer variation amount have the one-to-one correspondence with each other, an equation or a map indicating the above relation is prepared in advance. The frequency deviation calculating unit 203a calculates the frequency deviation from the buffer variation amount by using the above-mentioned equation or map.

FIG. 3B shows an example of a relation between the frequency deviation and the buffer variation amount. The buffer variation amount becomes zero when the frequency deviation is zero, i.e., when the frequency of the audio transmitting clock CK1 is equal to the frequency of the audio reproducing clock CK2. When the frequency deviation is a positive value, i.e., when the frequency of the audio transmitting clock CK1 is higher than the frequency of the audio reproducing clock CK2, the buffer variation amount becomes a positive value, and the buffer amount gradually increases. Conversely, when the frequency deviation is a negative value, i.e., the frequency of the audio transmitting clock CK1 is lower than the audio reproducing clock CK2, the buffer variation amount becomes a negative value, and the buffer amount gradually decreases. As described above, the frequency deviation and the buffer variation amount have the correlation with each other. Therefore, based on this correlation, the control unit 203 can obtain the frequency deviation from the buffer variation amount;

Instead of calculating the frequency deviation based on the buffer variation amount as described above, the control unit 203 may calculate the frequency deviation by accurately measuring the frequency of the audio transmitting clock CK1 and the frequency of the audio reproducing clock CK2. For example, the CPU of the control unit 203 can measure the frequency of the audio reproducing clock CK2 by counting the audio reproducing clock CK2 outputted from the clock generating unit 201, and the control unit 203 can measure the frequency of the audio transmitting clock CK1 based on the receiving data amount of the audio data per unit time.

Next, the receiving unit 205 transmits the control signal Sb indicating the frequency deviation calculated by the frequency deviation calculating unit 203a to the transmitting apparatus 100 by the frequency deviation transmitting unit 205a. The receiving unit 205 can transmit the above control signal via the CEC line.

Then, the transmitting unit 105 of the transmitting apparatus 100 receives the control signal Sb indicating the frequency deviation and transmitted from the receiving apparatus 200, by the frequency deviation receiving unit 105a. Then, the control unit 103 varies the audio reproducing clock CK2, which the VCXO 101y oscillates based on the above-mentioned frequency deviation, by the clock varying unit 103a. Specifically, the control unit 103 controls the voltage of the voltage generator 106 such that the frequency of the audio reproducing clock CK2 varies by the amount of the above-mentioned frequency deviation, thereby to vary the transmitting-side system clock. Since the audio transmitting clock CK1 follows the transmitting-side system clock, by appropriately varying the transmitting-side system clock, the transmitting apparatus 100 can consequently adjust the buffer amount of the receiving apparatus 200 and can prevent the overflow and the underflow of the buffer 203x. In addition, since the video transmitting clock also follows the transmitting-side system clock, the transmitting apparatus 100 can prevent the occurrence of the synchronization deviation of the video data and the audio data to be outputted.

Then, the control unit 103 produces the database of the frequency deviation and the identification information of the receiving apparatus 200 (hereinafter referred to as “equipment identification information”) by the storing unit 103b and stores it in the auxiliary storage unit 104. The transmitting apparatus 100 obtains the equipment identification information from the receiving apparatus 200 via the DEC line, for example. Particularly, it is preferred that the timing when the transmitting apparatus 100 obtains the equipment identification information coincides with the timing when the transmitting apparatus 100 obtains the above-mentioned control signal Sb indicating the frequency deviation.

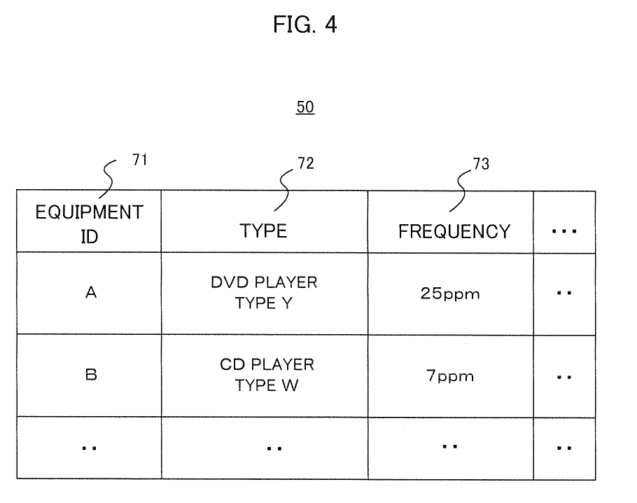

FIG. 4 shows an example of the database described above. The database 50 includes the equipment ID 71, type 72 and the frequency 73. In the storage contents of the database 50, the equipment ID 71 indicates a unique ID of the receiving apparatus 200. For example, UUID (Universally Unique Identifier) may correspond to the equipment ID 71. The type 72 indicates the product name and the product number of the transmitting apparatus 100. The frequency 73 indicates the frequency deviation or the frequency of the audio transmitting clock. (In the example of FIG. 4, the frequency 73 indicates the frequency deviation.) By the auxiliary storage unit 104 having the database 50, the transmitting apparatus 100 can obtain the frequency deviation for the receiving apparatus 200, with which the clock synchronization processing is once performed, by referring to the database 50. Therefore, when connecting with the receiving apparatus again to reproduce the contents, the transmitting apparatus 100 can use the frequency of the audio transmitting clock CK1 close to the audio reproducing clock CK2 in advance. By this, the transmitting apparatus 100 can correct the transmitting-side system clock early.

While the database 50 includes two information, i.e., the equipment ID 71 and the type 72 as the equipment identification information in the above example, the database 50 may include only one of them. Also, the equipment identification information may be, not completely unique information such as UUID, but information that overlap with sufficiently low possibility (e.g., the type 72) when the equipments are used at home.

[Processing Flow]

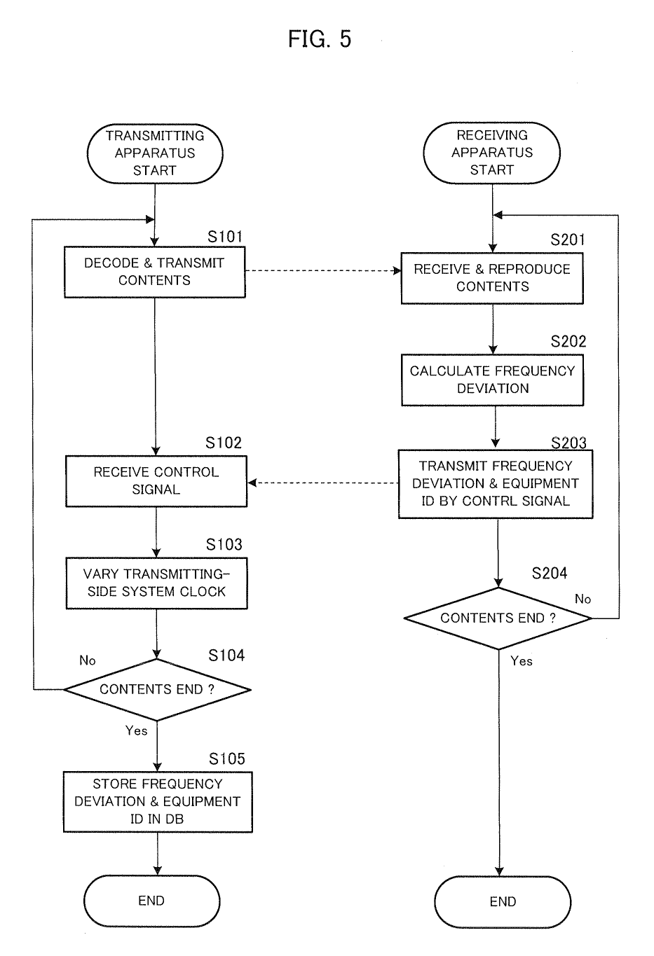

Next, the procedure of the clock synchronizing processing will be described with reference to the flowchart of FIG. 5. Steps S101 to S104 correspond to the processing that the transmitting apparatus 100 executes. Particularly, step S102 corresponds to the processing that the frequency deviation receiving unit 105a executes, step S103 corresponds to the processing that the clock varying unit 103a executes, and step S104 corresponds to the processing that the storing unit 103b executes. Also, steps S201 to S204 correspond to the processing that the receiving apparatus 200 executes. Particularly, step S202 corresponds to the processing that the frequency deviation calculating unit 203a executes, and step S203 corresponds to the processing that the frequency deviation transmitting unit 205a executes. The solid line arrow shows the flow of the processing, and the broken line arrow shows the flow of data.

First, the transmitting apparatus 100 decodes the contents by the control unit 103, and transmits the decoded contents to the receiving unit 200 (step S101). Then, the receiving apparatus 200 receives the contents and reproduces it (step S201). Specifically, the control unit 203 accumulates the audio data in the buffer 203x. Then, the control unit 203 supplies the audio data accumulated in the buffer 203x to the DAC 208x based on the audio reproducing clock CK2 generated by the clock generating unit 201. Also, the control unit 203 supplies the video data to the DAC 208y without accumulating it in the buffer 203x. Thus, the contents are reproduced by the audio output unit 206x and the video output unit 206y.

Next, the receiving apparatus 200 calculates the frequency deviation (step S202). Specifically, the control unit 203 calculates the frequency deviation based on the variation amount of the buffer amount. Or, the control unit 203 calculate the frequency deviation by accurately measuring the audio transmitting clock CK1 and the audio reproducing clock CK2.

The receiving apparatus 200 transmits the frequency deviation obtained in step S202 and the equipment identification information of the receiving apparatus 200 to the transmitting apparatus 100 (step S203). Specifically, the receiving unit 205 transmits them as the control signal under the control of the communication control unit 209. Then, the transmitting apparatus 100 receives the control signal by the transmitting unit 105 (step S102). The transmitting apparatus 100 communicates the above-mentioned control signal with the receiving apparatus 200 via the CEC line, for example.

Next, the transmitting apparatus 100 varies the transmitting-side system clock based on the information of the frequency deviation in the received control signal (step S103). Thus, the audio transmitting clock CK1 and the video transmitting clock are varied by this, because the audio transmitting clock CK1 and the video transmitting clock are generated based on the transmitting-side system clock.

Next, the receiving apparatus 200 continues the processing of steps S201 to S203 if the contents does not end, i.e., while the transmitting apparatus 100 is transmitting the contents (step S204; No). On the contrary, if the contents ends (step S204; Yes), the receiving apparatus 200 ends the processing of this flowchart.

On the other hand, if the contents does not end (step S104; No), the transmitting apparatus 100 continues the processing of steps S101 to S103. Therefore, the transmitting apparatus 100 continues the clock synchronizing processing at an arbitrary period during the reproduction of the contents.

Then, if the contents ends (step S104; Yes), the transmitting apparatus 100 stores the frequency deviation and the equipment identification information of the receiving apparatus, received in step S102, in the database 50 (step S105). By this, the transmitting apparatus 100 can easily know the frequency deviation by referring to the database 50, when the transmitting apparatus 100 executes the clock synchronizing processing with the same receiving apparatus 200 again. Namely, the transmitting apparatus 100 can quickly execute the clock synchronizing processing. Therefore, the transmitting apparatus 100 can reduce the burden on the processing associated with the clock synchronizing processing.

As described above, according to this embodiment, the transmitting apparatus which transmits audio data of contents, to a receiving apparatus electro-magnetically connected via a transmission medium, in accordance with an audio transmitting clock generated based on a transmitting-side system clock, comprising: a frequency deviation receiving unit which receives information indicating a frequency deviation between the audio transmitting clock and an audio reproducing clock of the receiving apparatus; and a clock varying unit which varies the transmitting-side system clock based on the information. Since the audio transmitting clock follows the transmitting-side system clock, the transmitting apparatus can vary the buffer of the receiving side according to the control, and can prevent the overflow and underflow of the buffer of the receiving side. Further, since the clock for transmitting the video also follows the transmitting-side system clock, the transmitting apparatus can prevent the occurrence of the deviation of the video and audio to be outputted.

[Producing Method of Receiving Apparatus]

The producing method of the receiving apparatus 200 according to this embodiment will be described here. When the receiving apparatus 200 is newly produced (designed), it is produced according to the configuration diagram of FIG. 1. On the other hand, as shown in the receiving apparatus 200 according to the Comparative Example-1, when the configuration of the receiving apparatus 200 without the buffer 203x is changed to the receiving apparatus 200 according to this embodiment, there are some conceivable modifying methods. One example of the modifying methods will be described here. First, the control unit 203 is changed to be a circuit which has a function to copy the audio data received by the receiving unit 205 to the buffer 203x and a function to manage the buffer 203x, i.e., a function to take out the audio data from the buffer 203x based on the audio reproducing clock CK2. In other words, out of the functions that the control unit 203 has, a part which directly takes the audio data from the receiving unit 205 in the Comparative Example-1 is changed to a part which takes out the audio data from the receiving unit 205, temporarily accumulates it in the buffer 203x and manages the buffer 203x. Thus, the receiving apparatus 200 according to the embodiment may be realized with a minimum software design change. In addition, by integrating the control unit 203 and the buffer 203x and enabling the control unit 203 to independently perform the reception of the audio data from the receiving unit 205, the change of the hardware configuration and the occurrence of cost due to the addition of device can be suppressed, thereby enabling the inexpensive configuration of the receiving apparatus 200.

### Modified Example

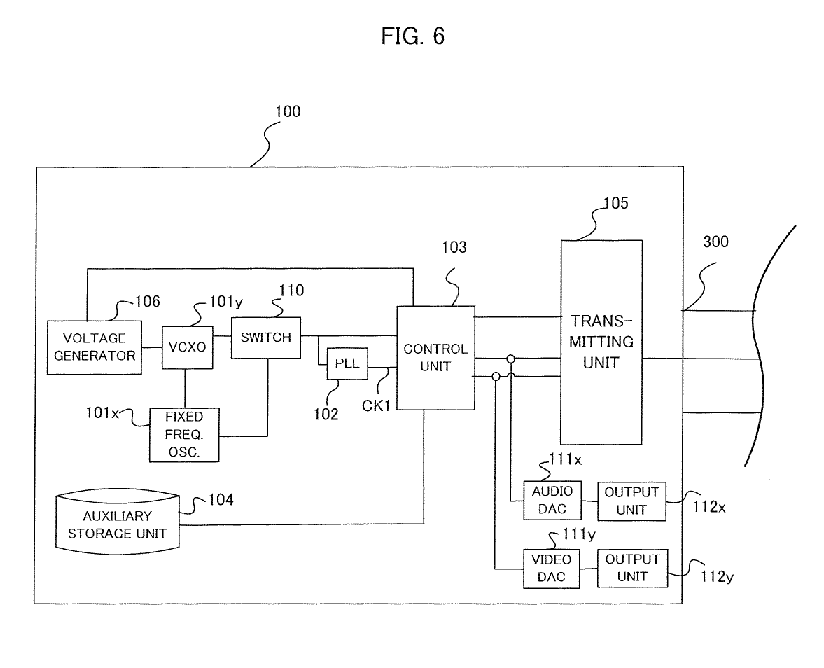

In the above embodiment, the transmitting apparatus 100 transmits the digital data to the receiving apparatus 200. However, the transmitting apparatus 200 normally has an analog output. Therefore, in that case, it is preferred that the transmitting apparatus 100 is configured as shown in the block diagram of FIG. 6. In FIG. 6, the transmitting apparatus 100 includes a switch 110, an audio DAC 111x, a video DAC 111y, an output unit 112x and an output unit 112y. When the transmitting apparatus 100 outputs the contents as digital output, the switch 110 supplies the clock signal from the VCXO 101y to the PLL 102 and the control unit 103. When the transmitting apparatus 100 outputs the contents as analog output, the switch 110 supplies the clock from the fixed frequency oscillator 101x to the PLL 102 and the control unit 103. At the time of the analog output, the audio DAC 111x and the video DAC lily receive the audio data and the video date, respectively, and convert the respective data to the analog signals. Then, the audio DAC 111x supplies the analog audio signal to the output unit 112x, and the video DAC lily supplies the video analog signal to the output unit 112y. The output unit 112x outputs the audio, and the output unit 112y outputs the video. Thus, the transmitting apparatus 100 can perform both the digital output and the analog output, and can directly use the clock of the fixed frequency oscillator 101x at the time of the analog output. Therefore, the reproduction can be performed with the clock of higher quality.

### INDUSTRIAL APPLICABILITY

This invention can be used for a contents reproducing system in which a receiving apparatus and a transmitting apparatus transmit the contents to reproduce the contents, as well as the receiving apparatus and the transmitting apparatus.

1.-10. (canceled)

11. A contents reproducing system which includes a transmitting apparatus and a receiving apparatus connected to the transmitting apparatus via a HDMI cable serving as a transmission medium, and which transmits and receives reproducing data including both video data and audio data,
the receiving apparatus comprising:
a buffer which accumulates the audio data transmitted from the transmitting apparatus;
a clock generating unit which generates an audio reproducing clock based on a fixed clock, without using a PLL;
a frequency deviation calculating unit which calculates a frequency deviation between an audio transmitting clock generated by the transmitting apparatus and the audio reproducing clock, based on a variation amount, per unit time, of the audio data accumulated in the buffer;
a frequency deviation transmitting unit which transmits the frequency deviation to a fixed frequency oscillating unit generating a transmitting-side system clock and a VCXO unit in the transmitting apparatus;
an audio output unit which outputs audio; and
a video output unit which outputs video,
wherein the receiving apparatus receives, via the HDMI cable, the reproducing data which includes the video data and the audio data transmitted in accordance with a video transmitting clock and the audio transmitting clock generated based on the transmitting-side system clock,
wherein the receiving apparatus outputs the audio data accumulated in the buffer from the buffer in accordance with the audio reproducing clock and outputs the audio data from the audio output unit,
wherein the receiving apparatus outputs the received video data from the video output unit in synchronization with the audio data,
wherein the receiving apparatus transmits the frequency deviation as a control signal to the transmitting apparatus via the HDMI cable by a CEC line,
wherein the transmitting apparatus comprising:
a frequency deviation receiving unit which receives the control signal indicating the frequency deviation from the receiving apparatus by the CEC line;
the fixed frequency oscillating unit which generates the transmitting-side system clock which is a basis of the video transmitting clock and the audio transmitting clock, and the VCXO unit;
a clock varying unit which varies the transmitting-side system clock by an amount of the frequency deviation in accordance with the control signal;
a video transmitting clock generating unit which generates the video transmitting clock; and
an audio transmitting clock generating unit which generates the audio transmitting clock,
wherein the transmitting apparatus varies the audio transmitting clock and the video transmitting clock by following the transmitting-side system clock varied in accordance with the control signal received from the receiving apparatus.

12. The contents reproducing system according to claim 11, wherein the transmitting apparatus continues clock synchronizing processing at an arbitrary period during reproduction of contents.

13. The contents reproducing system according to claim 11, wherein the transmitting apparatus comprises a storage unit which stores the frequency deviation and equipment identification information of the receiving apparatus, and obtains the frequency deviation for the receiving apparatus, with which clock synchronizing processing is once executed, by referring to the storage unit.

14. The contents reproducing system according to claim 11, wherein the receiving apparatus generates and decodes control commands communicated by the CEC line, which is a control communication channel in the HDMI.

15. The contents reproducing system according to claim 11, wherein the transmitting apparatus comprises a storage unit which stores an equation or a map indicating a relation between the frequency deviation and the variation amount.

16. A receiving apparatus which is connected to a transmitting apparatus via a HDMI cable serving as a transmission medium and which receives reproducing data including both video data and audio data, comprising:
a buffer which accumulates the audio data transmitted from the transmitting apparatus;
a clock generating unit which generates an audio reproducing clock based on a fixed clock, without using a PLL;
a frequency deviation calculating unit which calculates a frequency deviation between an audio transmitting clock generated by the transmitting apparatus and the audio reproducing clock, based on a variation amount, per unit time, of the audio data accumulated in the buffer;
a frequency deviation transmitting unit which transmits the frequency deviation to a fixed frequency oscillating unit generating a transmitting-side system clock and a VCXO unit in the transmitting apparatus;
an audio output unit which outputs audio; and
a video output unit which outputs video,
wherein the receiving apparatus receives, via the HDMI cable, the reproducing data which includes the video data and the audio data transmitted in accordance with a video transmitting clock and the audio transmitting clock generated based on the transmitting-side system clock,
wherein the receiving apparatus outputs the audio data accumulated in the buffer from the buffer in accordance with the audio reproducing clock and outputs the audio data from the audio output unit,
wherein the receiving apparatus outputs the received video data from the video output unit in synchronization with the audio data, and
wherein the receiving apparatus transmits the frequency deviation as a control signal to the transmitting apparatus via the HDMI cable by a CEC line.

17. A transmitting apparatus which is connected to a receiving apparatus via a HDMI cable serving as a transmission medium and which transmits reproducing data including both video data and audio data, comprising:
a frequency deviation receiving unit which receives a control signal indicating a frequency deviation from the receiving apparatus by a CEC line;
a fixed frequency oscillating unit which generates a transmitting-side system clock which is a basis of a video transmitting clock and an audio transmitting clock, and a VCXO unit;
a clock varying unit which varies the transmitting-side system clock by an amount of the frequency deviation in accordance with the control signal;
a video transmitting clock generating unit which generates the video transmitting clock; and
an audio transmitting clock generating unit which generates the audio transmitting clock,
wherein the transmitting apparatus varies the audio transmitting clock and the video transmitting clock by following the transmitting-side system clock varied in accordance with the control signal received from the receiving apparatus.
